(19) United States
(12) Patent Application Publication
(10) Pub. No.: US 2017/0254421 A1
(43) Pub. Date: Sep. 7, 2017

(54) METHOD AND APPARATUS FOR COUPLING A VALVE TO A VALVE ACTUATOR

(71) Applicant: Pac-Op Inc., Odessa, TX (US)

(72) Inventor: Cory Padgett, Odessa, TX (US)

(21) Appl. No.: 15/058,968

(22) Filed: Mar. 2, 2016

(51) Int. Cl. F16K 5/06; F16K 31/00

(52) U.S. Cl. CPC F16K 5/0647; F16K 31/00

(57) ABSTRACT

The specification describes methods and apparatus for coupling a rotary-actuated valve to a valve actuator that is configured to rotate a valve member within the valve. A shaft coupling assembly is used to provide a rotatable connection between the valve actuator and a valve actuation shaft through use of a clamp assembly which is moveable from non-engagement with the valve actuation shaft to secure engagement with opposing flats on the valve actuation shaft. Also described is a novel bracket assembly configured to support a valve and valve actuator in a desired spaced relation to one another which is sufficient to accommodate the described shaft coupling assembly.

### BACKGROUND

The present disclosure relates generally to methods and apparatus for coupling a valve, such as a rotary-actuated valve to a valve actuator configured to rotate the valve through a shaft connection with the valve; and more particularly relates to methods and apparatus for coupling such a valve actuator to the valve through use of an adjustable coupling. This adjustable coupling provides the ability to establish a tight and secure engagement with a valve actuation shaft, without reliance on compliance with high precision-machined components.

A problem can be experienced in the actuation of rotary-actuable valves through use of a valve actuator due to the shaft fitment on the valve being out of tolerance. Typically, such valves would include a double D shaft fitment which, in conventional practice will be received within a mating recess in a solid member. As a result, if either the shaft or the recess (or both) is out of fairly restrictive specifications (ideally no more than 0.00×× inch), then the result can be a connection that is sufficiently loose such that over repeated actuation cycles, one of the two members will become deformed. Typically this deformation will occur on the shaft member, and when the deformation becomes problematic to the effective operation of the valve, either replacement of the valve or of the entire actuation assembly thereof is required to return the unit to proper specifications. It would be desirable, however, to assure a secure and tight engagement in the coupling to a valve actuation shaft, as will avoid the risk of such deformation.

### BRIEF DESCRIPTION OF THE DRAWINGS

FIGS. 1A-B depict an example assembly for coupling a valve actuator to a valve, according to an embodiment of the present disclosure, depicted from a side perspective view; with the view of FIG. 1B rotationally offset from the view of FIG. 1B by approximately 90°.

FIG. 2 is an exploded-view depiction of an assembly for coupling a valve actuator to a valve that is generally similar to that depicted in FIGS. 1A-B, in relation to an example valve and actuator according to one or more embodiments of the present disclosure.

FIGS. 3A-C depict a shaft coupling assembly as shown in the assemblies of FIGS. 1-2; depicted from a side view in FIG. 3A, from a top view in FIG. 3B; and from a bottom view and in an assembled form in FIG. 3C.

FIG. 4 depicts the upper mounting bracket of the assembly of FIG. 2, depicted from a bottom plan view.

FIG. 5 depicts the lower mounting bracket of the assembly of FIG. 2, depicted from a top plan view.

FIGS. 6A-B depicted an example configuration of the orienting washer as depicted in FIG. 2.

FIG. 7 depicts an alternative configuration for the clamp assembly of the shaft coupling assembly of FIGS. 2 and 3.

FIG. 8 depicts an alternative configuration for the clamp assembly of the shaft coupling assembly of FIGS. 2 and 3.

### DETAILED DESCRIPTION

The present description describes methods and apparatus for coupling a rotary-actuated valve to a valve actuator configured to rotate a valve member within the valve. For purposes of the present description, the inventive subject matter will be described in the context of coupling a ball valve through a novel connection assembly to a valve actuator. A shaft coupling assembly is used to provide a rotatable connection between the valve actuator and the valve actuation shaft. The depicted shaft coupling assembly utilizes a clamp assembly, which is moveable from non-engagement with the valve actuation shaft to secure engagement with opposing flats on the valve actuation shaft.

The following detailed description refers to the accompanying drawings that depict various details of examples selected to show how particular embodiments may be implemented. The discussion herein addresses various examples of the inventive subject matter at least partially in reference to these drawings and describes the depicted embodiments in sufficient detail to enable those skilled in the art to practice the invention. Many other embodiments may be utilized for practicing the inventive subject matter than the illustrative examples discussed herein, and many structural and operational changes in addition to the alternatives specifically discussed herein may be made without departing from the scope of the inventive subject matter.

In this description, references to “one embodiment” or “an embodiment,” or to “one example” or “an example” in this description are not intended necessarily to refer to the same embodiment or example; however, neither are such embodiments mutually exclusive, unless so stated or as will be readily apparent to those of ordinary skill in the art having the benefit of this disclosure. Thus, a variety of combinations and/or integrations of the embodiments and examples described herein may be included, as well as further embodiments and examples as defined within the scope of all claims based on this disclosure, as well as all legal equivalents of such claims.

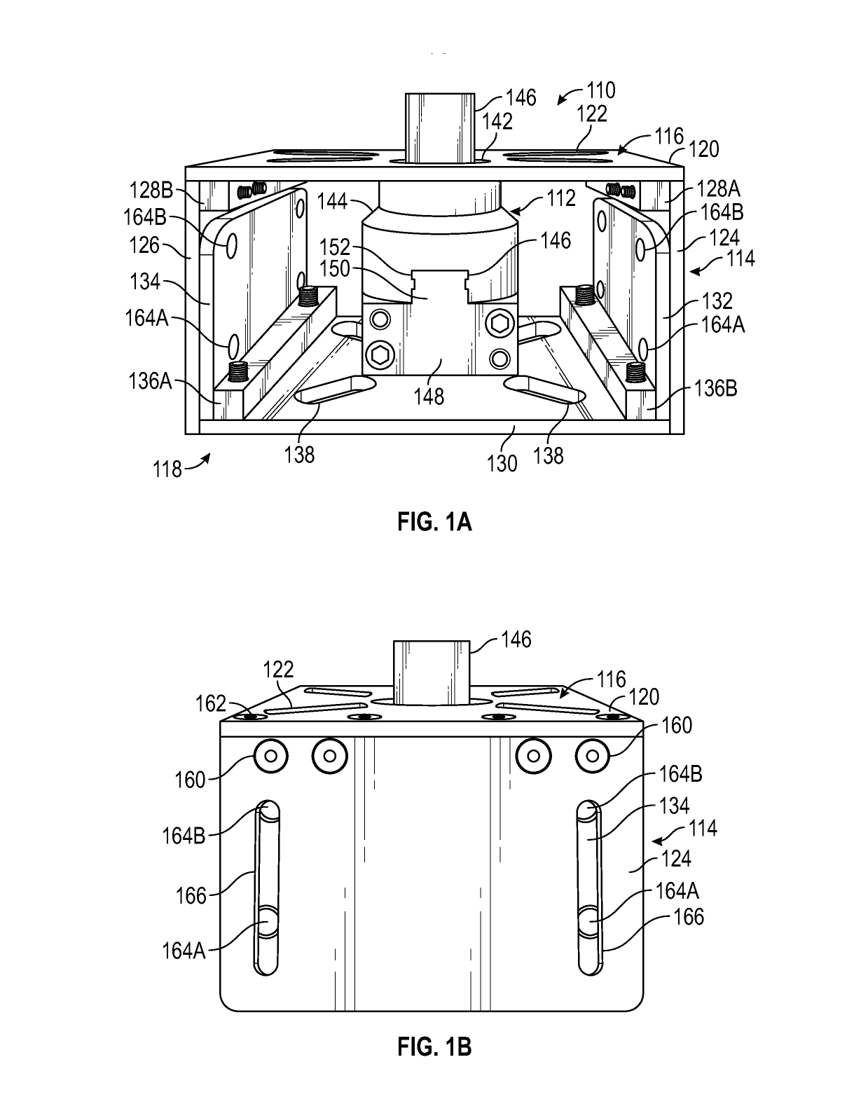

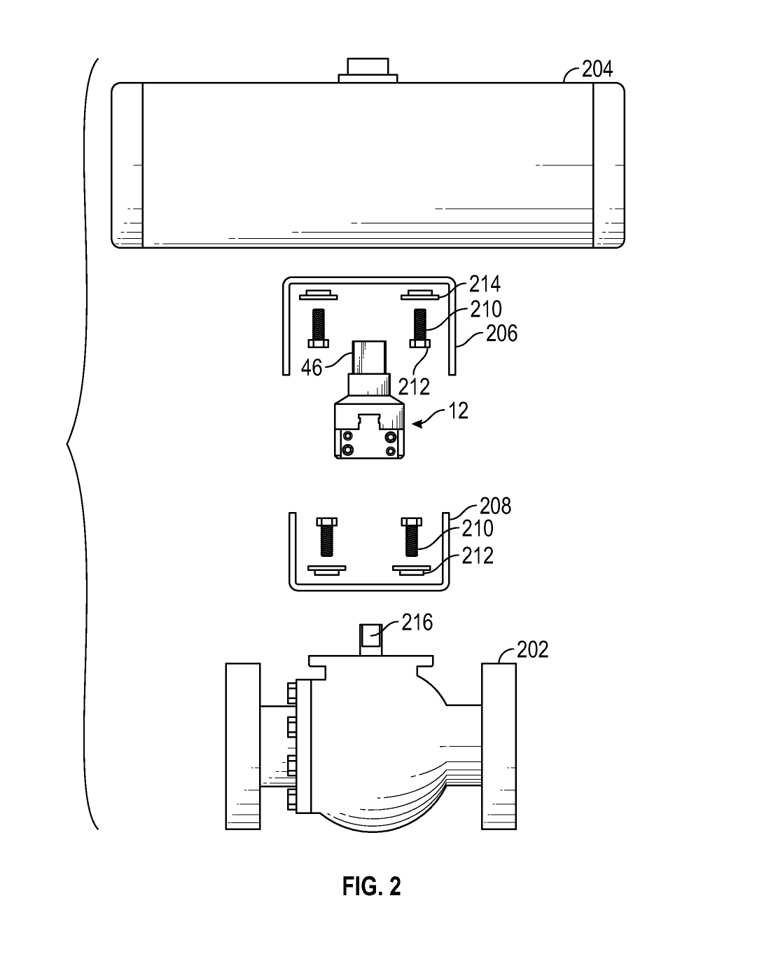

Referring now to FIGS. 1A-B of the drawings, those figures depict an example coupling assembly 100 for coupling a valve actuator to a valve, depicted from a side perspective view; with the view of FIG. 1B rotationally offset from the view of FIG. 1A by approximately 90 degrees. Coupling assembly 100 includes two principal components, a shaft coupling assembly, indicated generally at 112, and a mounting assembly, indicated generally at 114. Shaft coupling assembly 112 connects an actuation drive of a valve actuator to the valve actuation shaft of a valve (depicted in FIG. 2). Mounting assembly 114 is configured to facilitate coupling of a valve actuator and a valve in generally fixed relation to one another so that torque applied through shaft coupling assembly 112 results in rotation of the valve actuation shaft. Additionally, in the depicted example, mounting assembly 114 facilitates establishing an adjustable and appropriate separation distance between the valve actuator and the valve so as to accommodate the dimension of a suitable configuration of shaft coupling assembly 112.

In the depicted example, mounting assembly 114 includes an upper bracket, indicated generally at 116, and a lower bracket, indicated generally at 118. Upper bracket 116 and lower bracket 118 are cooperatively configured to telescope relative to one another to adjust the spacing established by mounting assembly 114. In the depicted example, this is achieved by each bracket having a generally U-shaped configuration, with the brackets placed in opposing relation to one another, with one bracket (in this case, lower bracket 118) sized and shaped to extend within the “U” formed by (relatively) inverted upper bracket 116.

Upper bracket 116 includes a central portion 120 (the bottom of the “U”) that forms the valve actuator mounting section, with a pair of flanges 124, 126 which extend from opposite sides of central portion 120. In the depicted example, flanges 124, 126 are each configured as separate elements from central portion 120, and are secured to central portion 120 by a respective attachment block, 128A, 128B facilitating bolted connections to both central portion 120 and a respective flange 124, 126. As will be addressed later in this description, upper bracket 116 and lower bracket 118 can instead each be formed of a single element which is shaped, such as by bending, casting, or another formation or shaping process, into the general U-shape (or other desired configuration). Upper bracket 116 includes a plurality of elongated slots, indicated typically at 122 (only partially visible in FIGS. 1A-B), and a separate central aperture 142 to facilitate attachment of upper bracket 116 to a valve actuator. Elongated slots 122 are preferably generally radially arranged relative to an axis of central aperture 142 which will also approximately serve as the axis of rotation of shaft coupling assembly 112, as will be discussed in more detail later herein. The radial arrangement of the slots, in combination with other structures as described later herein, facilitates a self-centering orientation of mounting assembly 114 relative to a corresponding bolt pattern on the valve actuator.

Lower bracket 118 is configured in a similar manner, having a central portion 130 that forms a valve mounting section, which is coupled to upwardly extending (as depicted) flanges 132, 134, through respective attachment blocks 136A, 136B, each of which is bolted to both central portion 130 and a respective flange 132 or 134. Central portion 130 again includes a plurality of elongated slots 140 generally radially arranged relative to a central aperture (not visible) to facilitate attachment of the bracket to a valve body. Again, this orientation of elongated slots, in combination with other structures described herein, provides a self-centering centering orientation of mounting assembly 114 relative to the valve body.

In order to facilitate the previously described adjustment of the separation distance established by mounting assembly 114, one bracket, in this case lower bracket 118, includes two pairs of vertically aligned bolt apertures 164A, 164B in each of flanges 132 and 134; and two vertically extending slots 166 in each of flanges 124 and 126, each slot 166 place to align with a pair of bolt apertures 164A, 164B, so that when upper bracket 116 and lower bracket 118 are placed into a desired telescoping relationship, the brackets may be bolted in fixed position through use of bolts (not illustrated) extending through each of bolt apertures 164A, 164B and a corresponding vertical slot 166.

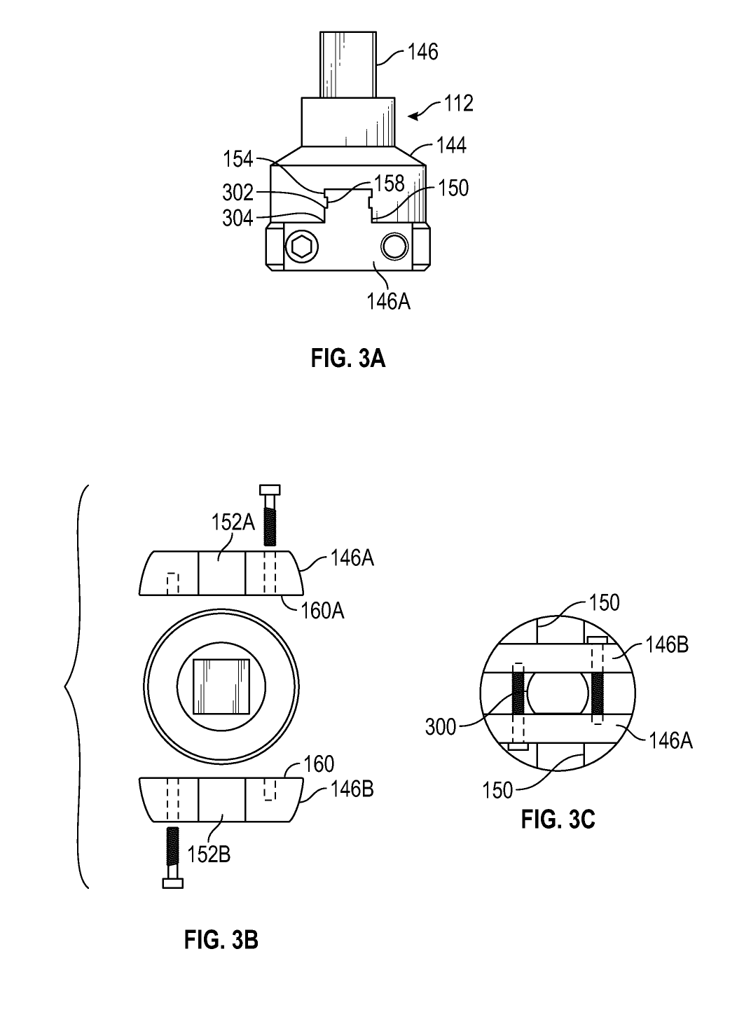

Shaft coupling assembly 112 includes a body member 144, which includes an extension 146 configured to engage the drive mechanism of a valve actuator. For many configurations of valve actuator, the extension will be a square drive of any one of multiple standard dimensions, such as 0.5″, 0.075″, 1.0″, (etc.); to engage a multi-point drive receiver in the valve actuator. In this example, body member 144 also defines, proximate a lower portion, a linearly-extending recess 150 which, in combination with a mating tongue 152 on a movable member 156A of a clamp assembly, forms a track assembly. As shown, recess 150 has a cross-sectional profile with at least one region of relatively expanded dimension, as shown at 154, relative to a region of relatively lesser dimension, as shown at 158, configured to serve as a keyway to maintain engagement of a complementarily-configured tongue 152 of a movable member within the recess 150, but allow longitudinal movement along the recess. In the depicted example embodiment, the clamp assembly includes a pair of opposing movable members 156A, 156B (only 156A is visible in FIG. 1), each having a tongue 152A, 152B configured to engage a corresponding recess. In a particularly preferred embodiment, as described herein, recess 150 will extend across the entire dimension of the lower portion of body member 144, with each movable clamping member 156A, 156B, translatable along the recess 150. However, in other embodiments, each movable member 156A, 156B of the clamping assembly can be retained within a separate respective recess. As will be apparent from the discussion to follow in reference to other figures, in this example configuration of a clamp assembly, each movable member 156A, 156B includes a flat surface region (160A, 160B, in FIGS. 3A-C), and these flat surface regions will engage opposite flat sides of a valve actuation shaft such as a shaft having a Double D shaft fitting (as depicted at 216 in FIG. 2). While the present specification discusses the common configuration of a double D shaft fitment on the valve actuation shaft, other shapes are known, such as, for example, a square drive head fitment. The present invention is equally applicable to use with a square head, as the clamp assembly can engage opposing flat surfaces of the square drive head in the same manner as described herein relative to the double D shaft fitment.

Referring now also to FIGS. 2-5, FIG. 2 depicts an exploded-view of an example assembly 200 for coupling a valve actuator to a valve that is generally similar to coupling assembly 100 of FIGS. 1A-B, shown in relation to an example valve 202 and actuator 204. Coupling assembly 200 differs from coupling assembly 100 of FIGS. 1A-B in that upper bracket 206 and lower bracket 208 are each formed of a single piece of metal which has been bent to form the U-shape of each bracket. Due to the otherwise similar structure between and coupling assembly 200 relative to coupling assembly 100, structures or features that are common to both embodiments are identified with the number used in reference to coupling assembly 100. Assembly 200 also depicts the example bolts 210 and locating washers 212 which facilitate centering of coupling assembly 200 relative to the axes of rotation of both the actuator 204 drive mechanism and of the valve actuation shaft 214.

Referring now specifically to FIGS. 3A-C, those figures depict the shaft coupling assembly 112 in greater detail, and from different perspectives as identified earlier herein. As can best be seen in FIG. 3A, recess 150 and mating tongue 152 have multiple corners formed in establishing the areas of different dimension in the cross-section; and preferably, each of these corners will have a chamfer form to minimize cracking. The precise contour of the chamfer may vary depending upon the size of particular cross-sectional configuration of recess 150 and mating tongue 152; as will be apparent to persons skilled in the art.

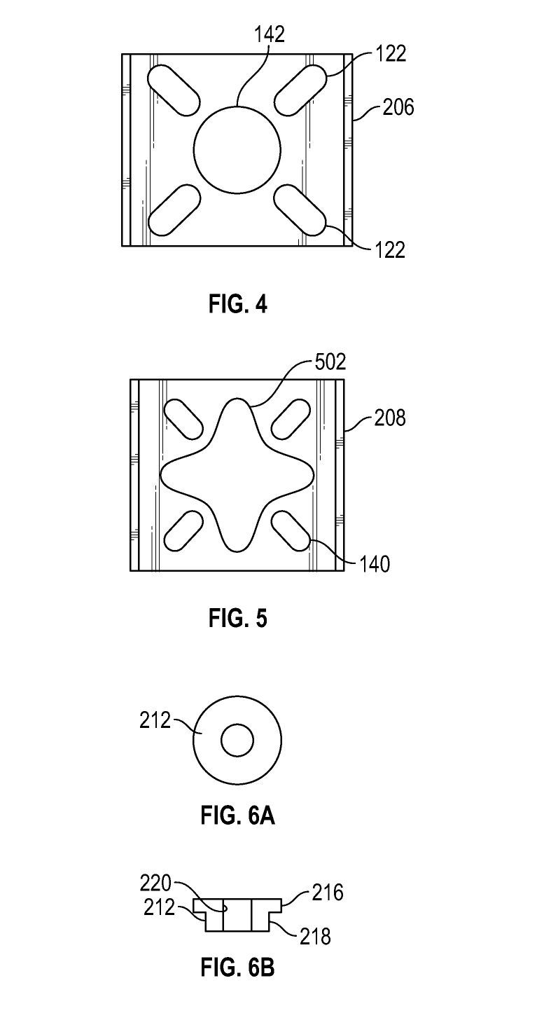

FIG. 4 depicts upper bracket 206 from a bottom plan view showing elongated slots 122 extending relative to central aperture 142, as was described in reference to coupling assembly 100 of FIGS. 1A-B. Similarly, FIG. 5 depicts lower bracket 208 showing elongated slots 138 extending radially relative to a center point of a central aperture 502 which is shaped and sized to allow clearance of any packing gland and related features of the valve (element 202 in FIG. 2).

Referring now also to FIGS. 6A-B, those figures depict an example locating washer 212 from a top or plan view in FIG. 6A; and from a side cross-sectional view in FIG. 6B. Each locating washer 212 includes an upper flange 216 and a centering sleeve 218 extending from upper flange 216, as well as a central bolt aperture 220. Centering sleeve 218 will have an exterior diameter sized to closely engage the width of longitudinal slots in either the upper bracket or the lower bracket (as depicted at 122 in upper bracket 116 in FIG. 1; or as depicted at 140 in lower bracket 118 in FIG. 1; or as depicted in FIGS. 4 and 5, respectively).

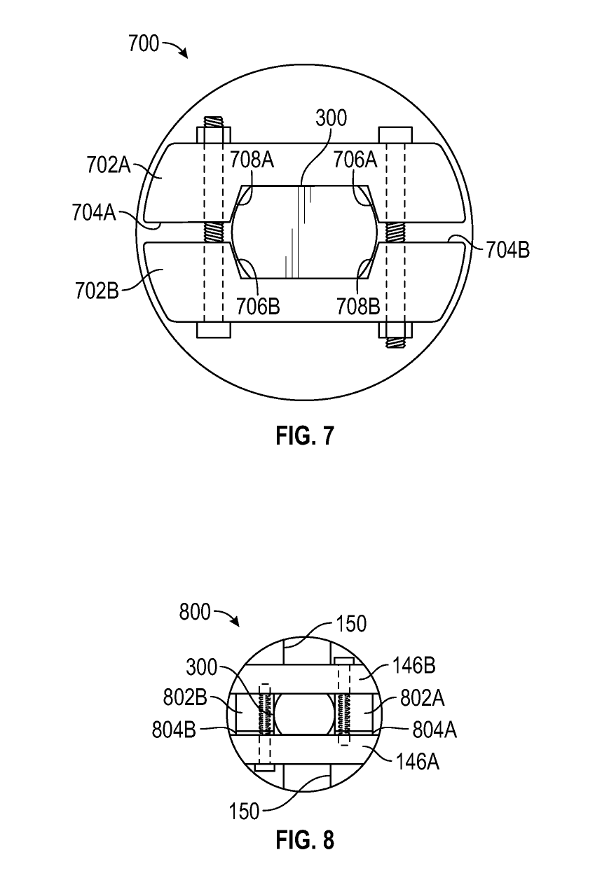

Shaft coupling assembly 112 in FIG. 2 is of the configuration discussed above in reference to FIG. 1, and has thus been numbered the same as in FIG. 1. Referring now also to FIGS. 3A-C, those figures depict the shaft coupling assembly 112 in greater detail. Shaft coupling assembly 112 is depicted from a side view in FIG. 3A, from a top exploded view in FIG. 3B; and from a bottom view and in assembled form in FIG. 3C. FIG. 3C depicts the clap assembly, which is this example includes two moveable members 156A, 156B located on opposite sides of a double D fitment 300 of valve actuation shaft 214, which are bolted together, and which each include flat surface regions 160A, 160B at least proximate the valve actuation shaft to tightly grip the opposing flats of the double D fitment 300, regardless of the accuracy of the fitment dimensions relative to applicable specifications. In the depicted example, the bolts extend in opposite directions, and each passes through a through hole in one moveable member and threadably engages a threaded bore in the other moveable member. In other embodiments, the bolts may engage nuts on the opposite side of the further moveable member instead of engaging the threaded bore. In the depicted example, the entire inner surface of each movable member is flat. However other configurations are possible, as can be seen in reference to FIG. 7 discussed later herein.

While the depicted example includes two movable members, each of which has a generally flat surface on the side that will engage the valve shaft, other configurations are possible. For example, it would be possible to use a clamping assembly having only a single movable member relative to a fixed member; though that configuration may be less desirable in some applications, as it may be somewhat more difficult to optimize the alignment of shaft coupling 112 with both the valve actuator drive mechanism and the valve shaft, since one side of the clamp assembly would then be fixed. Additionally, other configurations for a clamp mechanism may be utilized, such as, for example, a substitution of another form of closure mechanism in place of the pair of opposing bolts in the depicted example. As just one example, opposing movable members such as those depicted might be forced into engagement with the valve shaft through use of an annular collect mechanism configured to threadably engage the body member around the exterior of the movable members. In such a collect mechanism, a threaded collar having a ramp section might be used to engage the body member such that increase threading to the body member would result in the ramp section progressively compressing the movable members into tighter engagement with a valve shaft extending between the movable members. Persons skilled in the art having the benefit of this disclosure will be able to identify additional modifications or alternative configurations for the clamp assembly suitable for use in shaft coupling assembly 112.

Various materials may be utilized for the components of the coupling assembly. For example, the brackets of the mounting assembly 114 may often be formed of mild steel, such as A36 plate steel. The components of the shaft coupling assembly may be of a harder steel, such as 1045 carbon steel or 4140 alloy steel. As will be apparent to persons skilled in the art having the benefit of the present disclosure, if the assembly is to be used in an offshore or other corrosive environment, it may be desirable to use other materials resistant to such corrosion, such as, by way of example only, 302 stainless steel, 316 stainless steel, or 17-4PH stainless steel.

Referring now to FIG. 7, the figure depicts a bottom view of a shaft coupling assembly 700, depicting an alternative example configuration for the clamp assembly, including a different configuration for each movable member 702A, 702B. In the depicted example, the inner surface 704A, 704B, of each movable member 702A, 702B includes a respective recess 706A, 706B, with each recess having a flat bottommost surface 708A, 708B which will engage the double D shaft fitment (300 in FIG. 3) of a valve actuation shaft 214. The shaft coupling assembly 700 offers the advantage of minimizing the unsupported dimension of each bolt 710A, 710B coupling the movable members together; and therefore may offer advantages in minimizing the effects of torque applied through the clamp assembly.

Referring now to FIG. 8, the figure depicts an alternative configuration 800 for the clamp assembly, based upon the basic configuration of FIGS. 1-3. In this configuration, in order to provide additional stability and resistance to torqueing between the two movable members 146A and 146B, spacer elements are placed between the two moveable members, on opposite sides of the valve actuation shaft. The spacer elements can be of many possible configurations. One potentially desirable configuration for many applications will be to have a pair of spacer assemblies in which each includes a larger spacer block to occupy the majority of the space between the moveable members when they are fully bolted together, and one or more shims to allow fine adjustment of the spacing. The spacers facilitate placing a desired loading on the clamping force on the valve actuation shaft. This construction is shown in configuration 800, with a pair of spacer blocks 802A, 802B inserted between the movable members 146A and 146B. In this example, spacer blocks 802A, 802B are configured with a dimension extending between movable members 146A and 146B which is slightly less than the dimensions across the flats of double D fitting 300. As a result, one or more shims, indicated generally at 804A and 804B, will used to adjust the spacing such that tight engagement between movable members 146A and 146B may be achieved across both double D fitting 300 and spacer blocks 802A and 802B; and the shims can account for variances in the dimensions of the double D fitting. in some configurations, the spacer blocks 802A, 802B will have through holes to accommodate the coupling screws. However, in other embodiments, a generally U-shaped recess may be formed in an inner edge of each spacer block to provide a channel through which the respective coupling screw can extend.

Many variations may be made in the structures and techniques described and illustrated herein without departing from the scope of the inventive subject matter. Accordingly, the scope of the inventive subject matter is to be determined by the scope of the following claims and all additional claims supported by the present disclosure, and all equivalents of such claims.

What is claimed is:

1. A coupling assembly to couple a valve actuator to a valve, comprising:
a body structure having a drive extension configured to engage a drive mechanism of the valve actuator;
a clamp assembly having at least one member cooperatively configured with the body member to define a track allowing linear movement of a moveable portion of the clamp assembly relative to the body member.

2. The coupling assembly of claim 1, wherein the track extends in a radial direction relative to a central portion of the body member.

3. The coupling assembly of claim 1, wherein the track comprises a recess having a cross-section with a portion of an expanded dimension intermediate the depth of the recess formed in either the body structure or the portion of the clamp assembly; and further comprises a tongue configured to engage and to be retained within the recess by the portion of an expanded dimension formed therein, formed in the other of the body structure or the portion of the clamp assembly.

4. The coupling assembly of claim 3, wherein the track recess is formed in the body structure, and wherein the clamp assembly comprises at least one movable member having a tongue configured to be received and retained within the recess.

5. The coupling assembly of claim 4, wherein the clamping assembly comprises two movable members, with each movable member having a tongue configured to be received and retained within the recess.

6. The coupling assembly of claim 5, wherein the recess extends across the diameter of the body structure.

7. The coupling assembly of claim 6, wherein the two movable members of the clamping assembly are configured to engage opposing flat surfaces on an actuation shaft of the valve;
and are bolted to one another to engage and clamp the valve actuation shaft.

8. The coupling assembly of claim 7, wherein when the opposing flat surfaces on actuation shaft of the valve form a portion of a double D shaft fitting.

9. The coupling assembly of claim 7, wherein each of the movable members includes a flat surface placed to engage the opposing flat surfaces on the actuation shaft of the valve.

10. The coupling assembly of claim 9, further comprising a mounting assembly for securing the valve and the valve actuator in fixed relation to one another on opposite sides of the body structure and clamp assembly.

11. The coupling assembly of claim 10, wherein the mounting assembly comprises:
a first bracket having a valve actuator mounting section and a first pair of engagement flanges extending from the valve actuator mounting section;
a second bracket having a valve mounting section, and a second pair of engagement flanges extending from the valve mounting section and spaced to extend in over lapping relation to the first pair of engagement flanges.

12. The coupling assembly of claim 4, further comprising spacer elements between the two moveable members, the spacer elements arranged on opposite sides of the valve actuation shaft.

13. A method of coupling a valve actuator to a valve, comprising:
coupling the valve and valve actuator in spaced relation to one another through use of a mounting assembly;
mechanically coupling a drive mechanism of the valve actuator to a valve actuation shaft of the valve through use of a shaft coupling assembly, wherein the shaft coupling assembly includes,
a body structure having a drive extension configured to engage the drive mechanism of the valve actuator; and
a clamp assembly coupled to the body structure, the clamp assembly having at least one movable member to engage the valve actuation shaft of the valve, and adjustable in position to adapt the dimension of the clamp assembly to securely engage the valve actuation shaft.

14. The method of claim 13, wherein the at least one moveable member of the clamp assembly is configured with the body structure to define a track limiting the moveable member movement to linear movement relative to the body member.

15. The method of claim 13, wherein at least one movable member of the clampassebly is linearly movable within a recess formed in the body structure.

16. The method of claim 14, wherein the track comprises:
a recess having a cross-section with a portion of an expanded dimension intermediate the depth of the recess formed in either the body structure or the portion of the clamp assembly; and
a tongue configured to engage and to be retained within the recess by the portion of an expanded dimension formed therein, formed in the other of the body structure or the portion of the clamp assembly.

17. The method of claim 14, wherein the clamping assembly comprises two movable members, with each movable member having a tongue configured to be received and retained within the recess; wherein the recess extends across the diameter of the body structure; and wherein the two movable members of the clamping assembly are configured to engage opposing flat surfaces on the valve actuation shaft.
